(19) United States
(12) Patent Application Publication
(10) Pub. No.: US 2020/0413456 A1
(43) Pub. Date: Dec. 31, 2020

(54) METHOD FOR PAIRING AND CONNECTING SECONDARY EARPHONE WITH SOUND SOURCE DEVICE

(71) Applicant: Tymphany Acoustic Technology (Huizhou) Co., Ltd., Huizhou City (CN)

(72) Inventor: Hung-Fen CHEN, Huizhou City (CN)

(21) Appl. No.: 16/717,393

(22) Filed: Dec. 17, 2019

(30) Foreign Application Priority Data
Jun. 26, 2019 (CN) 201910561726.5

(51) Int. Cl. H04W 76/10; H04W 4/80; H04R 5/04; H04R 5/033

(52) U.S. Cl. CPC H04W 76/10; H04W 4/80; H04R 2420/07; H04R 5/033; H04R 5/04

(57) ABSTRACT

The present application provides a method for establishing a connection between a primary earphone, a secondary earphone and a sound source device, the method comprises the following steps: connecting the primary earphone to the sound source device according to a pairing data, wherein the pairing data contains a communication information of the primary earphone; synchronizing and storing the pairing data from the primary earphone to the secondary earphone; and if the primary earphone is connectable for the sound source device, connecting the primary earphone to the sound source device according to the pairing data; if the primary earphone is not connectable for the sound source device, connecting the secondary earphone to the sound source device according to the pairing data which is synchronized from the primary earphone.

### TECHNICAL FIELD

The present invention relates to earphone connecting method, in particular to a method for establishing a connection between a primary earphone, a secondary earphone and a sound source device.

### BACKGROUND ART

Existing wireless headphones, such as Bluetooth® headsets, are already very common. When a wireless headphone is made into two earplug type earphones, the two earphones are required to be differentiated into a primary earphone and a secondary earphone. With reference to FIG. 1, an existing secondary earphone 12 establishes a paired connection with a sound source device 20 via a primary earphone 10, for example, the primary earphone 10 is automatically paired with and connected to the secondary earphone 12 so as to control the secondary earphone 12; such control may be, for instance, adjusting the volume. Next, the primary earphone 10 establishes a paired connection with the sound source device 20, such as a mobile phone a computer and the like, and receives audio data from the sound source device 20; the primary earphone 10 then transmits the audio data from the sound source device 20 to the secondary earphone 12 for playback.

It is noted that during the paired connection, only the primary earphone is utilized as a relay control device, with the primary earphone establishing a connection with both the secondary earphone and the sound source device. Should the primary earphone not operate normally, perhaps due to power outage or other failure, the connection between the secondary earphone and the sound source device will be interrupted.

The existing secondary earphone 12 establishes an indirect connection with the sound source device 20 via the primary earphone 10, receiving audio data and/or a control instruction from the sound source device 20 via this indirect connection. Therefore, once the primary earphone is powered off, is not activated, fails or is lost, a Bluetooth® communication module built in the secondary earphone 12 must be switched from a secondary mode to a primary mode (equivalent to a pairing mode), and re-execution of the action of connecting to the sound source device 20 must be undertaken; in such a case, the secondary earphone 12 can be regarded as another primary earphone. The above-described re-pairing action and steps may be time-consuming and prove bothersome to a user.

### SUMMARY OF THE INVENTION

In view of the existing status, a part of the embodiments of the present invention provide a method for pairing and connecting a secondary earphone with a sound source device, suitable for directly pairing and connecting the secondary earphone with the sound source device.

In one embodiment, the method for establishing a connection between a primary earphone, a secondary earphone and a sound source device, the method comprises the following steps: connecting the primary earphone to the sound source device according to a pairing data, wherein the pairing data contains a communication information of the primary earphone; synchronizing and storing the pairing data from the primary earphone to the secondary earphone; and if the primary earphone is connectable for the sound source device, connecting the primary earphone to the sound source device according to the pairing data; if the primary earphone is not connectable for the sound source device, connecting the secondary earphone to the sound source device according to the pairing data which is synchronized from the primary earphone.

In one embodiment, when the primary earphone is connectable and the secondary earphone connects to the primary earphone, the sound source device transmits the audio data to the secondary earphone via the primary earphone.

In one embodiment, when the primary earphone is connectable and the secondary earphone doesn't connects to the primary earphone, the sound source device transmits the audio data to the primary earphone.

In one embodiment, when the primary earphone is not connectable and the secondary earphone connects to the sound source device, the sound source device transmits the audio data to the secondary earphone.

In one embodiment, wherein the pairing data comprises the username, password or other accessing requirement data for accessing to the sound source device.

In one embodiment, wherein the communication information comprises the wireless communication address for accessing to the sound source device.

In one embodiment, wherein the wireless communication address is Bluetooth address.

With reference to the following detailed description of specific embodiments in connection with the drawings, the objective, technical content and features of the present invention and effects achieved thereby will become easier to understand.

### BRIEF DESCRIPTION OF THE DRAWINGS

FIG. 1 is a schematic view of a method for pairing and connecting a secondary earphone with a sound source device in the prior art;

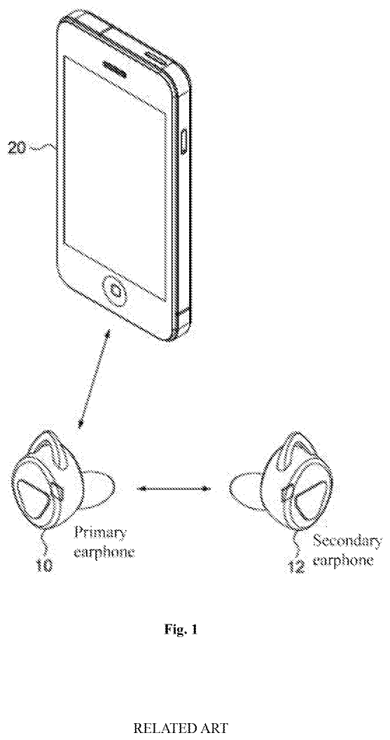

FIG. 2 is a schematic view of the method for pairing and connecting a secondary earphone with a sound source device according to one embodiment of the present invention;

FIG. 3 is a schematic view of the architecture of the method for pairing and connecting a secondary earphone with a sound source device according to one embodiment of the present invention; and

FIG. 4 is a detailed schematic view of the method for pairing and connecting a primary earphone and a secondary earphone with a sound source device according to one embodiment of the present invention.

### DETAILED DESCRIPTION OF THE EMBODIMENTS

The embodiments of the present invention will be described in details hereafter in connection with the drawings. Other than the detailed descriptions, the present invention can also be widely implemented in other embodiments. Any easy substitutions, modifications, equivalent variations of the embodiments should are to be considered as being within the scope of the present invention, and should be subject to the scope of the patent. In the description of the specification, in order to enable a reader to completely understand the present invention, a lot of specific details are provided. However, the present invention can still be implemented under the premise of omitting a part of, or the whole specific details. In addition, steps or assemblies forming part of common general knowledge are not described in detail, so as to avoid forming unnecessary limit to the present invention. The same or similar assemblies in the drawings will be denoted with the same or similar symbols. It should be specially noted that the drawings are for illustrative purpose only, and do not represent the actual sizes or quantities of the assemblies.

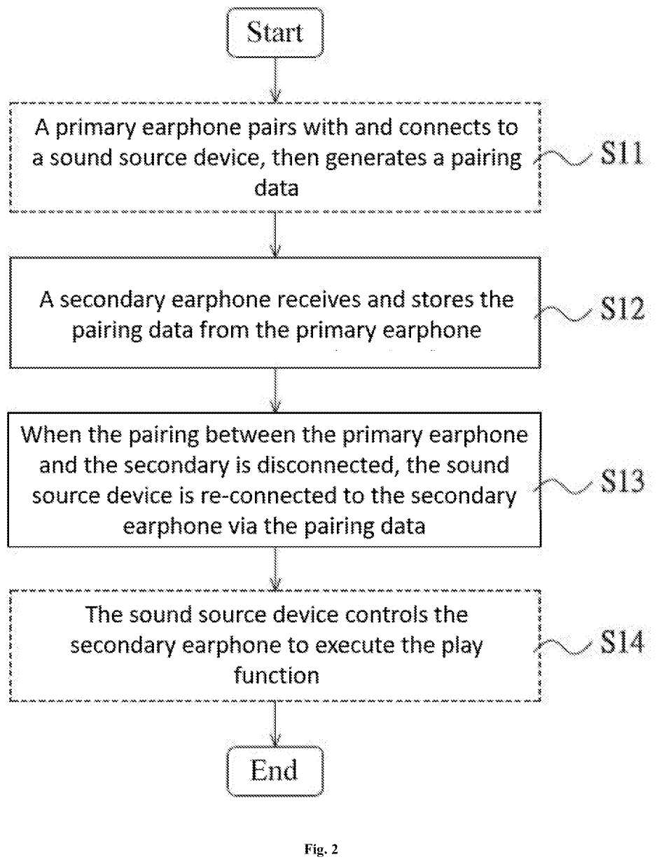

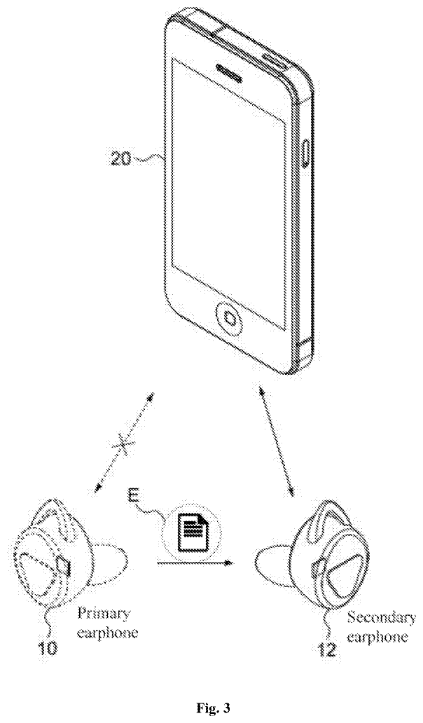

With reference to FIG. 2 and FIG. 3, the embodiments of the present invention with regard to the method for pairing and connecting a secondary earphone with a sound source device will be described hereafter. First, the primary earphone 10 and the secondary earphone 12 are automatically paired and connected; for example, the primary earphone 10 and the secondary earphone 12 can be pre-set to be connected (equivalent to a pre-setting of a primary-secondary relationship). Alternatively, in another example, the primary earphone 10 is able to establish a connection with the secondary earphone 12 via a Bluetooth® or other wireless communication protocol, such that the primary earphone 10 can control the secondary earphone 12 and/or transmit audio data to the secondary earphone 12 via the connection.

In one embodiment, the primary earphone 10 contains communication information, and is capable of establishing a paired connection with the sound source device 20 via a wireless communication protocol. The sound source device 20 can be a mobile phone or other similar device having a wireless communication functionality, and is capable of connecting to the wireless earphones 10 and 12. For example, the primary earphone 10 can have a Bluetooth® address, and the sound source device 20 may search for the Bluetooth® address of the primary earphone 10 via a Bluetooth® communication protocol. When the sound source device 20 finds the Bluetooth® address of the primary earphone 10, the sound source device 20 establishes a paired connection with the primary earphone 10, thus the sound source device 20 can perform data exchange with the primary earphone 10. Therefore, the primary earphone 10 may generate pairing data, E, based on the paired connection, and record relevant data such as the communication information, an access password and other relevant data for supporting and maintaining the connection. In particular, the pairing data may comprise the username, password and/or other accessing requirement data which the primary 10 and/or secondary 12 earphone needs for establishing a connection with the sound source device. Additionally, the communication information comprises the wireless communication address for accessing and/or establishing a connection with the sound source device, this being especially a Bluetooth® address. That is, in step S11, the primary earphone 10 pairs with and connects to the sound source device 20, then generates pairing data E, wherein the pairing data E contains the communication information of the primary earphone 10, in this embodiment, the communication information is a Bluetooth® address.

In the embodiment, the primary earphone 10 and the secondary earphone 12 are automatically paired and connected, as described above. Therefore, in step S12, the secondary earphone 12 receives and stores the pairing data E from the primary earphone 10, wherein the relevant data of the pairing data E is already described as above. Therefore, the secondary earphone 12 can acquire the Bluetooth® address of the primary earphone 10 which is recorded in the pairing data E, and treats the Bluetooth® address as a virtual Bluetooth® address of the secondary earphone 12. Thus, the virtual Bluetooth® address of the secondary earphone 12 originates from the Bluetooth® address of the primary earphone 10, and these two addresses are the same.

In this embodiment, the sound source device 20 and the primary earphone 10 are paired and connected, and the primary earphone 10 and the secondary earphone 12 are paired and connected. By means of these paired connections, the audio data can firstly be transmitted from the sound source device 20 to the primary earphone 10, and is then forwarded from the primary earphone 10 to the secondary earphone 12; in this way, stereo audio can be played via the primary earphone 10 and the secondary earphone 12. In some embodiments, the audio data can further comprise the play instruction or other playback-related instruction.

When the secondary earphone 12 disconnects from the primary earphone 10, for example: the secondary earphone 12 battery is empty; the secondary earphone 12 is turned off; the secondary earphone 12 is broken; or the secondary earphone 12 is missing, given that the sound source device 20 and the primary earphone 10 are still paired and connected, the primary earphone 10 can continue to play mono audio via the direct connection.

In another case, when the primary earphone 10 disconnects from the sound source device 20, perhaps as a result of one of the various reasons given above, the pairing between the primary earphone 10 and the secondary earphone 12 would also be disconnected; that is, the secondary earphone 12 and the sound source device 20 could be disconnected. In such a case, the secondary earphone 12 may not be able to receive the audio data of the sound source device 20 via the indirect connection. In step S13, the sound source device 20 will trigger a search for Bluetooth® devices function, and will locate the secondary earphone 12 as a result of this having the same pairing data, E, as the primary earphone 10. The sound source device 20 is then connected to the secondary earphone 12 via the virtual Bluetooth® address and the access password recorded in the pairing data, E, without having to re-execute the pairing steps. Thus, this invention provides a solution to simplifying the operation and reducing the time spent in connecting with the secondary earphone 12. When the pairing between the primary earphone 10 and the secondary earphone 12 is disconnected, the secondary earphone 12 will be paired with and connected to the sound source device 20 by use of the pairing data E.

On the basis of the description above, after the secondary earphone 12 is automatically paired with the primary earphone 10, it will receive the same pairing data E of the primary earphone 10. The secondary earphone 12 is then capable of being paired with and connected to the sound source device 20. Therefore, the secondary earphone 12 can be used separately from the primary earphone 10. After the secondary earphone 12 is activated, the secondary earphone 12 can automatically and directly be connected to the sound source device 20, without having to be switched to a main (or connection) mode and having to directly establish an access right to the sound source device 20.

In Step S14, the secondary earphone 12 can then receive audio data from the sound source device 20 via the above-described direct connection, and can proceed to play mono audio. That is, the sound source device 20 controls the secondary earphone 12 to execute the playback function.

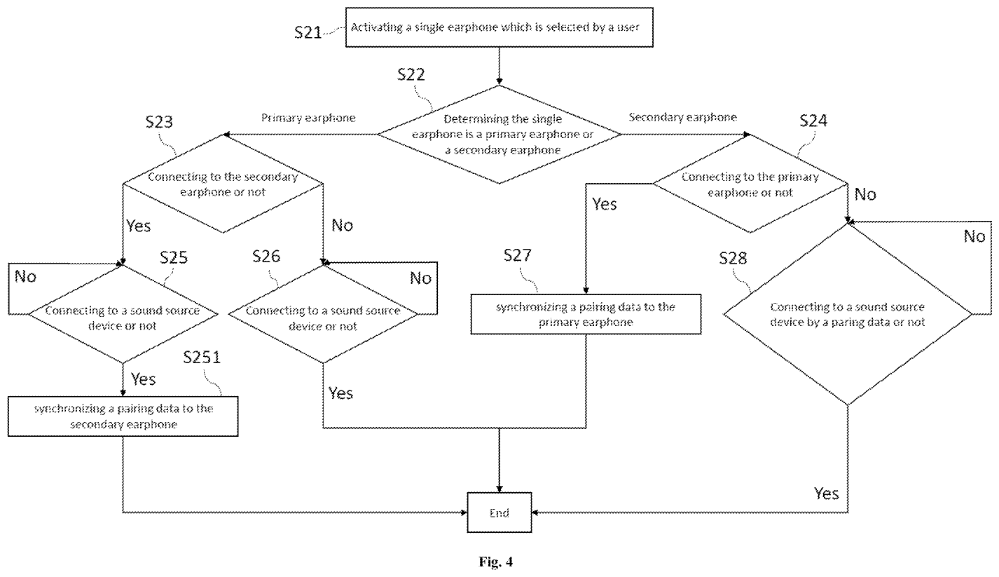

Referring to FIG. 4, the embodiments of the present invention with regard to a detailed method for pairing and connecting a primary earphone 10 and a secondary earphone 12 with a sound source device 20 will be described. As shown in FIG. 4: in step S21, when the user wants to use a headphone set, the user does not or may not know which one is the primary earphone 10 and which one is the secondary earphone 12. In such a scenario, the user will randomly pick a single earphone and then activate the selected single earphone. In step S22, when the selected single earphone is activated, it will be determined whether the single earphone is a primary earphone 10 or a secondary earphone 12, wherein the determination is made by the selected single earphone. In other embodiments, the determination can also be made by a charging box (not shown in the figures) which is used to accommodate the primary earphone 10 and the secondary earphone 12; in this embodiment, the primary earphone 19 and the secondary earphone 12 will both be automatically and wirelessly connected to the charging box when they be activated. When the activated single earphone is determined to be a primary earphone 10, step S23 will be executed and the secondary earphone 12 will automatically be connected. On the contrary, when the activated single earphone is determined to be a secondary earphone 12, step S24 will be executed, whereby the primary earphone 10 will automatically be connected to the secondary earphone 12.

When the primary earphone 10 is successfully connected to the secondary earphone 12 in step S23, the method will proceed to step S25 at which point the primary earphone 10 is connected to the sound source device 20. When the primary earphone 10 is successfully connected to the sound source device 20, the primary earphone 10 has already generated pairing data for establishing a wireless connection with the sound source device 20, and step S251 will be executed next, which is the synchronization of, which can include transmission of, the pairing data, E, to the secondary earphone 12. Therefore, the secondary earphone 12 also has the same pairing data E for wireless connection as the primary earphone 10. If the primary earphone 10 is not successfully connected to the sound source device 20, the primary earphone 10 will not generate the pairing data, E, and the primary earphone 10 will repeatedly execute step S25, attempting to establish a connection with the sound source device 20.

In step S23, when the primary earphone 10 is not successfully connected to the secondary earphone 12, step S26 will be executed and the primary earphone 10 will be connected to the sound source device 20. When the primary earphone 10 successfully connects to the sound source device 20, the primary earphone 10 will generate pairing data, E, for establishing a wireless connection with the sound source device 20; the difference between step S26 and step S25 is that the pairing data, E, cannot be synchronized with (nor transmitted to) the secondary earphone 12 in step S26, because the primary earphone 10 is not connected to the secondary earphone 12 for the moment. Here, synchronization should be understood as the primary earphone 10 ensuring consistency and uniformity of the pairing data, E, at the secondary earphone 12 and that this is the same as that held at the primary earphone 10; if this is not the case then the pairing data, E, from the primary earphone 10 is updated and saved at the secondary earphone 12. If in step S26, the primary earphone 10 is not successfully connected to the sound source device 20, then step S26 will be repeatedly executed in order to establish a connection with the sound source device 20.

In step S24, when the secondary earphone 12 is successfully connected to the primary earphone 10, step S27 will be executed. In step S27, the secondary earphone 12 synchronizes the last-used pairing data, E, with the primary earphone 10; that is the secondary earphone 12 coordinates and checks the consistency and uniformity of the last-used pairing data, E, held in the secondary earphone 12 with that held by the primary earphone 10—wherein if this differs, the pairing data E from the secondary earphone 12 is used to update the primary earphone 10. In this manner, the primary earphone 10 does not need to go through the re-connection process to the sound source device 20 as the pairing data, E, is already provided by the secondary earphone 12. At this point the primary earphone 10 and secondary earphone 12 are appropriately able, that is they have the relevant pairing data E, to initiate and make a connection with the sound source device 20. At this stage, one of the primary earphone 10 or secondary earphone 12 will initiate connection with the sound source device 20 using the pairing data E, and the other earphone will connect to the earphone which makes the connection with the sound source device 20. In step S24, when the secondary earphone 12 is not successfully connected to the primary earphone 10, step S28 will be executed. In step S28, since the secondary earphone 12 is not successfully connected to the primary earphone 10, the secondary earphone 12 can utilize the last-used pairing data to establish a connection to the sound source device 20; once the secondary earphone 12 successfully connects to the sound source device 20 via, that is by using, the last-used pairing data, E, then the user can start listening to sound playback. If, by contrast, the secondary earphone 12 is not successfully connected to the sound source device 20 by using the last-used pairing data, E, then step S28 is repeatedly executed to attempt to establish a connection between the secondary earphone 12 and the sound source device 20.

In the embodiment of the present invention regard to the method for pairing and connecting a secondary earphone 12 with a sound source device 20, even when the Bluetooth® communication module of the secondary earphone 12 still remains in slave mode, the secondary earphone 12 can be paired with the sound source device 20. This allows the access connection of the headphones, in particular the secondary earphone 12, to the sound device 20, so as to receive the control instruction and/or the audio data from the sound source device 20. Therefore, the secondary earphone 12 does not require switching to the main (or connection) mode in order to re-pair with the sound source device 20.

In summary, according to the method for pairing and connecting a secondary earphone 12 with sound source device 20 which is disclosed in the present invention, the secondary earphone 12 establishes a direct connection with the sound source device 20 by using virtual communication information wherein this is as same as the communication information, E; of the primary earphone 10. Such a paired connection between the secondary earphone 12 and the sound source device 20, can be directly established without executing a re-pairing operation to set the secondary earphone 12 in the different (that is connection) mode. Therefore, the present invention can omit the bothersome and inconvenient operations that are required in conventional pairing solutions, avoid the problem of disconnection when the primary earphone 10 is not connectable, and can effectively utilize a single secondary earphone 12 to provide a mono audio play function.

The embodiments above are only used to describe the technical concept and features of the present invention, and are intended to enable a person skilled in the art to understand the content of the present invention and implement according thereto, but not to limit the patent scope of the present invention. All the equivalent variations and modifications made in the spirit of the present invention shall still be concluded in the patent scope of the present invention, which is defined by the claims.

1. A method for establishing a connection between a primary earphone, a secondary earphone and a sound source device, wherein the method comprises the following steps:
attempting to connect the primary earphone to the sound source device according to pairing data, wherein the pairing data contains communication information of the primary earphone;
synchronizing and storing the pairing data from the primary earphone to the secondary earphone; and
if the primary earphone can be connected with the sound source device, connecting the primary earphone to the sound source device according to the pairing data; or
if the primary earphone cannot be connected with the sound source device, attempting to connect the secondary earphone with the sound source device according to the pairing data which was received from the primary earphone.

2. The method according to claim 1, wherein when the primary earphone is connected to the sound source device and the secondary earphone connects to the primary earphone, the sound source device transmits data to the secondary earphone via the primary earphone.

3. The method according to claim 1, wherein when the primary earphone is connected to the sound source device and the secondary earphone does not connect to the primary earphone, the sound source device transmits data to the primary earphone.

4. The method according to claim 1, wherein when the primary earphone is not connected to the sound source device and the secondary earphone connects to the sound source device, the sound source device transmits data to the secondary earphone.

5. The method according to claim 1, wherein the pairing data comprises the username, password and/or other accessing requirement data for establishing a connection with the sound source device.

6. The method according to claim 1, wherein the communication information comprises the wireless communication address for establishing a connection with the sound source device.

7. The method according to claim 6, wherein the wireless communication address is a Bluetooth® address.
